(19) United States
(12) Patent Application Publication
(10) Pub. No.: US 2007/0120040 A1
(43) Pub. Date: May 31, 2007

(54) System and method for minimizing holes on slab floor when forming tilt concrete walls

(76) Inventor: Gregory L. Hollon, Middletown, OH (US)

Correspondence Address: DENNIS G. LAPOINTE;LAPOINTE LAW GROUP, PL, PO BOX 1294, TARPON SPRINGS, FL, 34688-1294, US

(21) Appl. No.: 11/326,051

(22) Filed: Jan. 4, 2006

Related U.S. Application Data
(63) Continuation-in-part of application No. 11/289,738, filed on Nov. 29, 2005.

(51) Int. Cl. B29C 33/30

(52) U.S. Cl. 249/205; 249/139

(57) ABSTRACT

An apparatus and method for bracing a form laid out for the construction of a tilt-up wall includes a device which is configured to engage with a structural frame member. The device has a tab depending from its bottom side, which is configured to be inserted within a control joint of a slab floor on which the tilt-up wall form is laid out. One end of the structural frame member is secured to a side of an outside perimeter of the form and the structural member is attached to the device.

### RELATED APPLICATION

This application is a continuation-in-part of application Ser. No. 11/289,738 filed Nov. 29, 2005.

### FIELD OF THE INVENTION

The invention relates to tilt wall construction of concrete wall.

### BACKGROUND OF THE INVENTION

The problem with the method of forming tilt walls that is presently being used is all the form work has to be drilled and nailed into the new slab floor. Many of the slabs do not get covered with any type of coverings. The concrete sub-contractor must go back and patch all of these holes. There can be several hundred holes that need to be patched. Even after these holes have been patched, they are very obvious and make a new slab look old and ugly. There are no known method has yet been found that works well to eliminate these drilled holes.

### SUMMARY OF THE INVENTION

The present invention is designed to be used in forming tilt walls without having to drill holes in the slab to hold form work in place while concrete is being poured. The invention uses the saw-cut control joints in the slab which are required.

The present inventive system includes a device which has a hollow generally rectangular shaped adapted to pass through its hollow interior a structural member, typically a 2×4 or 2×6 frame lumber. An alternative to the rectangular-shaped device is an open top U-shaped channel or an L-shaped angle form portion. In these alternative embodiments, the frame lumber is inserted in the void of the U-shaped portion or placed against the side of the angle form portion and attached such as by nailing. The device has a tab or tail piece depending from its bottom side and is sized to be inserted in a saw-cut control joint required for slab floors typically associated with buildings being constructed with tilt-up wall construction methods. Preferably the tab can be adapted so that when it is inserted into the control joint, the bottom of the device is relative flush with the slab floor. For example, a tab might be ⅛ inch thick, 2 inches wide and 1 inch long. Certainly, the width and length can be varied or the tab can be designed so that its depth (length) of the tab can be shortened in the field. The device also has apertures or holes on one or more surfaces through which one or more nails can be temporarily nailed into the structural member.

When a form for a tilt-wall is configured, the device and its tab can be placed at a suitable distance from the outside of the frame where the tab is inserted in the control joint for positioning. One end of the frame member is positioned against the form side and the frame member is attached, as appropriate, to the device using nails. Nails are then hammered from inside the form through the end of the frame member and through the top side of the sleeve into the frame member, thereby providing a form brace to hold the form straight as the concrete is being poured. A desired number of these sleeve and frame members are located around the perimeter of the tilt-up wall form to maintain the overall form shape as the concrete is being poured.

The sleeve can be made from a variety of rigid materials, including metal, plastic based composite materials and other suitable materials. For example, it made from a metallic material, 7 gauge thickness material would be work quite well.

As an adjunct to the inventive system is a method of bracing common bulkheads in the forms of tilt-up walls. In addition to the above-described bracing around the outside perimeter of the forms, there is a need to brace between common bulkhead forms. Between the bulkhead forms, a re-bar mat is used to reinforce the tilt-up wall. The present invention includes the use of a flanged cap that receives a re-bar member, typically about 4 feet long. The flange has apertures in it which serve as means for nailing the cap to the inside surface of the bulkhead form. With an end of the re-bar member inserted inside the cap, the re-bar member is aligned to be tied to the re-bar mat. The cap and its inserted re-bar member is pushed tight against the form and nailed in place. Bulkhead forms may for example, be 20 feet apart so the 4 foot section of re-bar has a free end that extends into the form interior in the form lay out. It is preferred that these cap and re-bar members be aligned to be generally aligned with each outside brace provided by the above-described sleeve, tab and frame member combination.

The flange cap can be made from several materials known to be suitable; however, a plastic based composite material or an elastomeric rubberized material is preferred. The receiving part of the cap for the re-bar member end can be designed and sized to receive and hold with a snug fit typical size re-bar, such as ⅝ inch re-bar. Although various size caps can be made, it is known how to make universal caps where the receiving portion can be made to accommodate several sizes. For example, one known method is to provide an expandable opening so that a cap can receive multiple diameter re-bar members, such as a ½ inch re-bar or a ⅝ inch re-bar.

The invention includes an associated methodology for bracing such forms. The method comprises providing a plurality of frame lumber support devices, each device adapted to receive a structural frame member and to which said frame member is temporarily secured, each device further having a tab depending from a bottom side of the sleeve, and the tab being configured to be inserted within a control joint of a slab floor on which the tilt-up wall form is laid out; and locating control joints in the slab floor where bracing is desired and for each location, placing the tab into the control joint, securing one end of each structural frame member to a side of an outside perimeter of the form where desired and securing the structural frame member at an intermediate location to the device.

The means for securing the device to the structural member can be one or more apertures through which nails can be temporarily secured into the intermediate location of the structural frame member.

The method further comprises providing means for use in bracing common bulkhead forms, said means for use in bracing common bulkhead forms comprising a flanged cap, the flanged cap having means for securing the cap to an inside surface of one of the common bulkhead forms, and the flanged cap having means for receiving and securing an end of a re-bar member of a desired length. A desired number of caps are secured to the inside surface of the common bulkhead forms at each location that generally aligns with the outside perimeter tilt-up wall form bracing.

The means for securing the cap to the inside surface of one of the common bulkhead forms can be one or more apertures through which nails can be driven into the one of the common bulkhead forms.

For each secured cap, the re-bar member of desired length is inserted and secured to a re-bar mat between the common bulkhead forms.

### BRIEF DESCRIPTION OF THE DRAWINGS

In the accompanying drawings:

FIG. 1 is a conceptual depiction of the invention applied to a form for a tilt-up wall;

FIG. 2A is a depiction of an example of a device and its tab used for bracing the outside perimeter of a form;

FIG. 2B is a conceptual depiction of the sleeve and tab of FIG. 2A being used to brace a form;

FIG. 2C is another example of a device and its tab used for bracing the outside perimeter of a form;

FIG. 2D is a conceptual depiction of the device and tab of FIG. 2C being used to brace a form;

FIG. 2E is another example of a device and its tab used for bracing the outside perimeter of a form;

FIG. 3A is a depiction of an example of a cap for use between bulkhead forms; and

FIG. 3B is a depiction of the cap of FIG. 3A with the re-bar member inserted on one side.

### DETAILED DESCRIPTION OF THE INVENTION

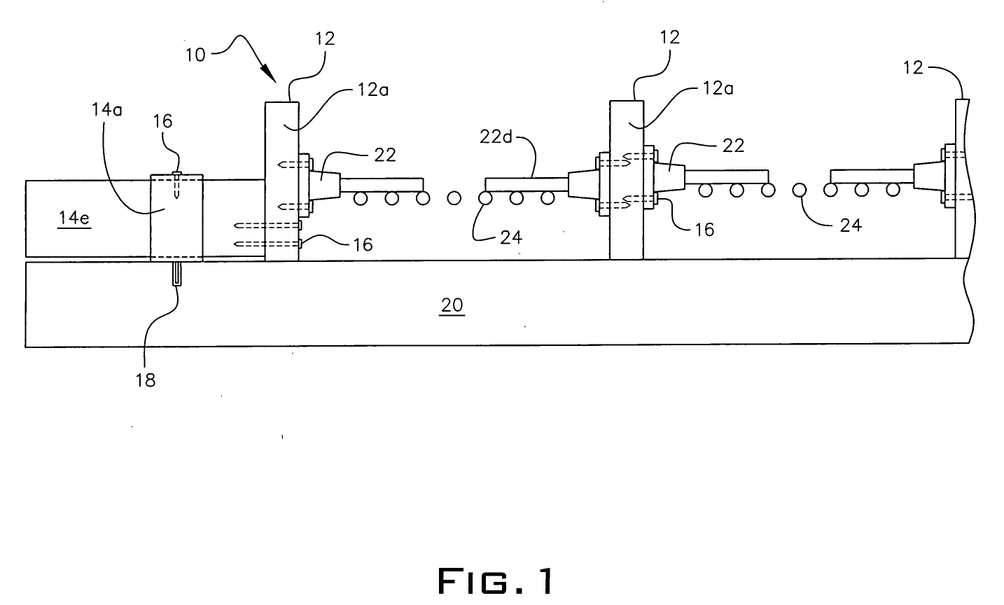

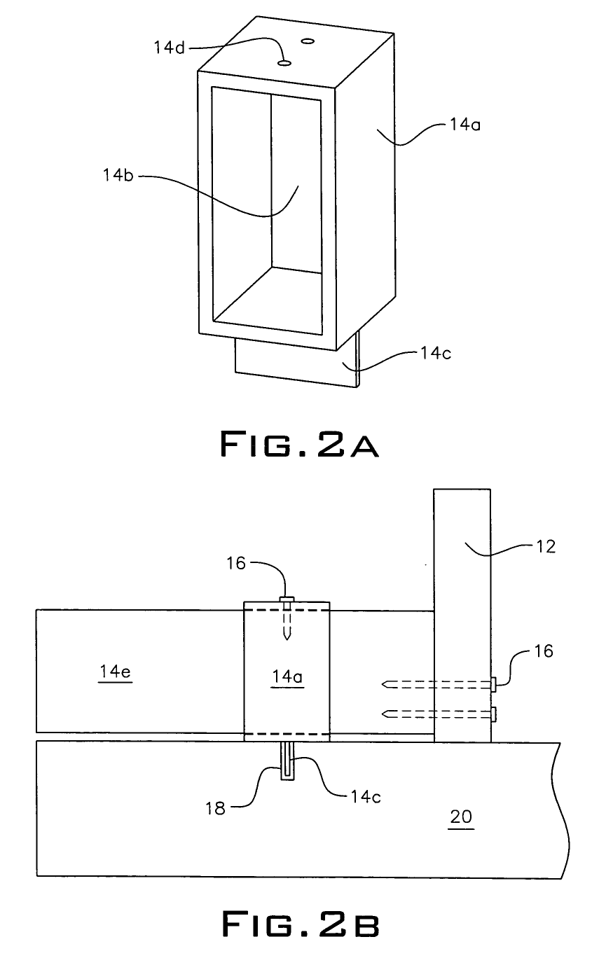

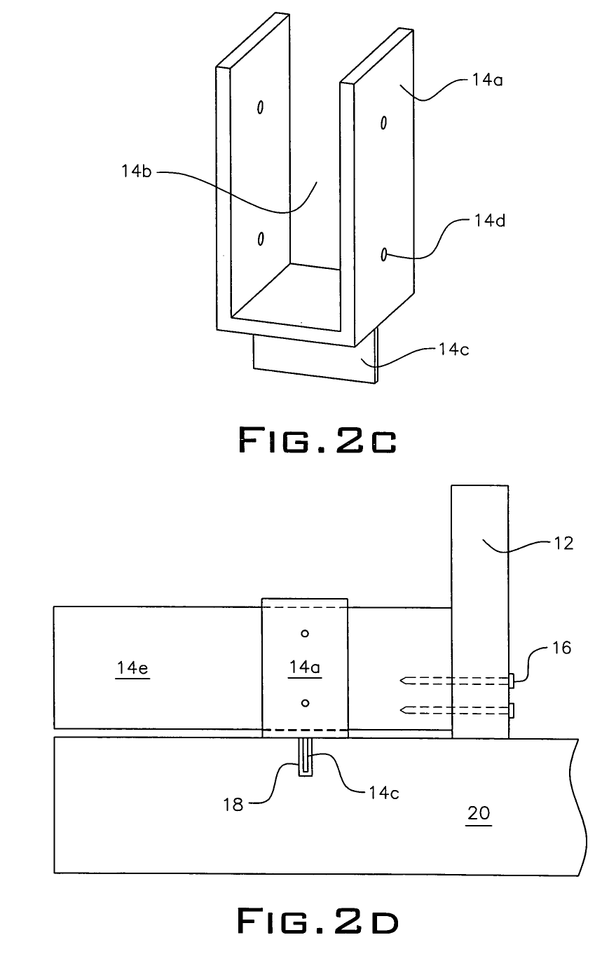

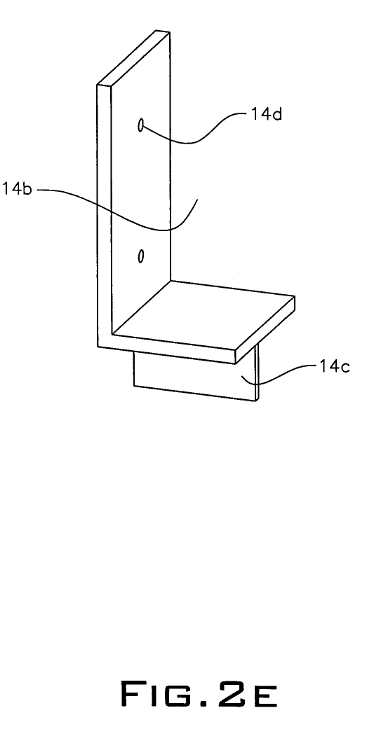

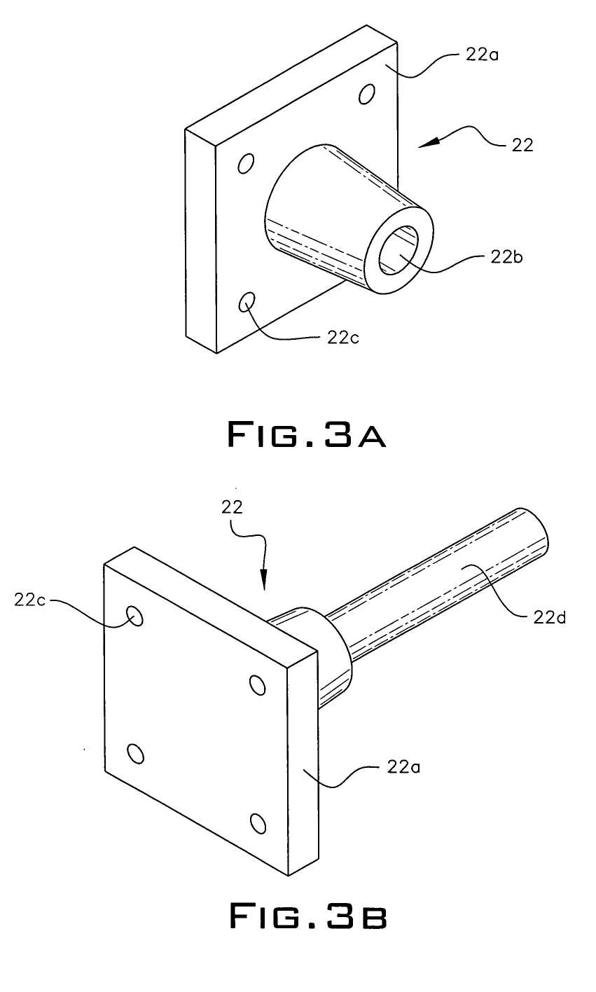

Referring now to the drawings, FIGS. 1, 2A-2E, 3A and 3B conceptually disclose the present invention, which is a system and method for bracing forms used in the tilt-up construction industry to eliminate the need for drilling holes in the concrete slab of buildings being constructed with tilt-up walls, and is depicted generally as 10.

The invention 10 is used for bracing a form 12 laid out for the construction of a tilt-up wall to be poured within such form 12.

It comprises a frame lumber support device 14a to which a structural frame member 14e is securable. Device 14a is adapted to receive a structural frame member 14e through its interior 14b or against one of its sides, and a tab 14c depending from a bottom side of the device 14a, the tab 14c being configured to be inserted within a control joint 18 of a slab floor 20 on which the tilt-up wall form 12 is laid out, wherein one end of the structural frame member 14e is secured to a side of an outside perimeter of the form 12 where desired and the structural frame member 14e is secured at an intermediate location to the device 14a.

The means for securing the device 14a to the structural frame member 14e is one or more apertures 14d through which nails 16 can be temporarily secured into the intermediate location of the structural frame member 14e.

The present invention 10 further comprises means for use in bracing common bulkhead forms 12a. The means for use in bracing common bulkhead forms 12a comprises a flanged cap 22. The flanged cap 22 includes means for securing the cap 22 to an inside surface of one of the common bulkhead forms 12a and the flanged cap has means 22b for receiving and securing an end of a re-bar member 22d of a desired length. The means 22b for receiving and securing an end of a re-bar member 22d of a desired length is typically a hole configured to secure the end of the re-bar member 22d.

The means for securing the cap 22 to the inside surface of one of the common bulkhead forms 12a is one or more apertures 22c through the flanged portion 22a of the cap 22 through which nails can be driven into the one of the common bulkhead forms. The flanged cap 22 is secured to the inside surface of one of the common bulkhead forms where desired and the re-bar member 22d extending away from said inside surface is tied to a re-bar mat 24 between the common bulkhead forms 12a.

It should be understood that the preceding is merely a detailed description of one or more embodiments of this invention and that numerous changes to the disclosed embodiments can be made in accordance with the disclosure herein without departing from the spirit and scope of the invention. The preceding description, therefore, is not meant to limit the scope of the invention. Rather, the scope of the invention is to be determined only by the appended claims and their equivalents.

What is claimed is:

1. Apparatus for use in bracing a form laid out for the construction of a tilt-up wall to be poured within such form, the apparatus comprising:
a frame lumber support device configured to engage with and secure a structural frame member;
a tab depending from a bottom side of the device, the tab being configured to be inserted within a control joint of a slab floor on which the tilt-up wall form is laid out; and
wherein one end of the structural frame member is secured to a side of an outside perimeter of the form where desired and the structural frame member is secured at an intermediate location to the device.

2. The apparatus according to claim 1, further comprising means for securing the structural frame member to the device.

3. The apparatus according to claim 2, wherein said means for securing the structural frame member to the device is one or more apertures through which nails can be temporarily secured into the intermediate location of the structural frame member.

4. The apparatus according to claim 1, wherein the device comprises a rectangular-shaped portion through which the structural frame member is passed.

5. The apparatus according to claim 1, wherein the device comprises a U-shaped portion in which the structural frame member is inserted to be secured.

6. apparatus according to claim 1, wherein the device comprises a L-shaped portion, wherein the structural frame member is placed against its inside surfaces to be secured.

7. A method of bracing a form laid out for the construction of a tilt-up wall to be poured within such form, the method comprising:
providing a plurality of frame lumber support devices, each device configured to engage with and secure a structural frame member and having a tab depending from a bottom side of the device, the tab being configured to be inserted within a control joint of a slab floor on which the tilt-up wall form is laid out; and
locating control joints in the slab floor where bracing is desired and for each location, placing the tab into the control joint, securing one end of each structural frame member to a side of an outside perimeter of the form where desired and securing the structural frame member at an intermediate location to the device.

8. The method according to claim 7, wherein each device further comprises means for securing the structural frame member to the device.

9. The method according to claim 8, wherein the means for securing the structural frame member to the device is one or more apertures through which nails can be temporarily secured into the structural frame member.
